(19) United States
(12) Patent Application Publication
(10) Pub. No.: US 2008/0134307 A1
(43) Pub. Date: Jun. 5, 2008

(54) Methods for programming a PIN that is mapped to a specific device and methods for using the PIN

(75) Inventors: Zvika Ashkenazi, Cupertino, CA (US); Tong Zhu, Fremont, CA (US); Davi B. Ottenheimer, Santa Cruz, CA (US)

Correspondence Address: MPG, LLP AND YAHOO! INC., 710 LAKEWAY DRIVE, SUITE 200, SUNNYVALE, CA, 94085, US

(73) Assignee: Yahoo, Inc., Sunnyvale, CA (US)

(21) Appl. No.: 11/607,281

(22) Filed: Dec. 1, 2006

(51) Int. Cl. G06F 21/00; G06F 17/00

(52) U.S. Cl. 726/6

(57) ABSTRACT

Methods for assigning a personal information number (PIN) to a device for accessing digital services from the device are provided. One of the methods include defining a PIN for the device from a website upon confirming credentials of a user and then mapping the PIN to the device at the website. The method then includes receiving an access request from the device for digital services and forwarding the device a request to enter the PIN on the device. If the PIN entered on the device matches the PIN mapped at the website, then the PIN is activated to enable accessing the digital services from the device using the PIN without having to enter credentials of the user on the device. The device is one having a limited data entry interface. Examples of the device include mobile phones, remotes for interactive televisions, and other limited data entry computing devices.

### BACKGROUND

1. Field of the Invention

The present invention relates to programming procedures used to define login processes for devices, and more particularly to method for defining easy to enter personal information numbers (PINs) that are mapped to particular devices.

2. Description of the Related Art

The computing industry has seen many advances in recent years, and such advances have produced a multitude commercially available products. These products include, for example, mobile phones, portable computers, automobile computers, home computers and networks, television computing equipment and the like. Additionally, many of these products are programmed with Internet capabilities and access. Although these products provide modern users with many options for communication, portability, and access to networked information (e.g., when connected to the Internet), some devices may hold personal information or access that needs to be protected. For this reason, many services on the Internet and access to particular devices require that users input some password information.

The way passwords are entered vary greatly, depending on the type of services and/or depending on the type of device being used. For example, the ease of entering passwords on a computer is relatively uncomplicated, as most computers (e.g., desktops and laptops) have standard qwerty keyboards. With a standard qwerty keyboard, users are able to enter password key strokes without complication, even if the password data requires different combinations of user names, email addresses, and special letter and number combinations.

In recent years, users have been provided more computing power and network access on portable devices and non-traditional computing platforms. Although these devices may provide users with access to more information, these devices are not typically provided with qwerty keyboards. For instance, mobile phone users are required to typing word strings, characters and numbers using multiple key taps. By necessity, users are becoming familiar with multiple key tap entry, but even the most experienced uses of multiple key tap entry make mistakes and/or are required to reenter key taps until the correct data is entered.

Although possible to enter the data in this manner, as more services are made available to non-traditional computing devices, the need for more comprehensive access security for given services and data necessarily increases. Service providers have therefore established more rigorous password and authentication processes, which are designed to provide authorized use or access to sensitive data. These improved processes, however, also increases the complexity for entering the data on the multiple key tap pads (e.g., such as traditional mobile phones, personal digital assistances, etc). As a result of having more rigorous passwords and authentication processes, users have become frustrated when attempting to access services for which they pay, and in some cases, users cancel services simply because access of the services is to cumbersome, time consuming or complex.

Other devices, such as home entertainment systems that are controlled by remote controls also suffer from the difficulties in interfacing with software that requires user input of complex passwords. For instance, some television service providers enable users to access particular programming upon entry of a password or code. The programming access is sometimes blocked to avoid having unauthorized use by certain members of a family or to simply access data or Internet access and services. In each case, users are asked to enter passwords or number sequences using remote controls, and in some cases, other people sitting in the vicinity may actually view the passwords as they are entered on the television screen. Even when programs block or mask data entry, people in the vicinity may actually be able to view which keys are being pressed. If the passwords is made more complex, users entering masked data may forget which keys had been pressed or which keys still need to be pressed to complete the entry of the password.

In view of the foregoing, there is a need for methods that enable personal identification numbers (PINs) to be created to easily and securely gain access to particular device services, and methods for managing the PINs to ensure security of their use.

### SUMMARY

Embodiments of the present invention provide methods for assigning a fast login PIN to particular devices, so full credential information need not be entered on limited data entry interfaces to use particular digital services, but still enabling high security and authentication.

It should be appreciated that the present invention can be implemented in numerous ways, such as a process, an apparatus, a system, a device or a method on a computer readable medium. Several inventive embodiments of the present invention are described below.

In one embodiment, a method for assigning a personal information number (PIN) to a device for accessing digital services from the device is disclosed. The method includes defining a PIN for the device from a website upon confirming credentials of a user and then mapping the PIN to the device at the website. The method then includes receiving an access request from the device for digital services and forwarding the device a request to enter the PIN on the device. If the PIN entered on the device matches the PIN mapped at the website, then the PIN is activated to enable accessing the digital services from the device using the PIN without having to enter credentials of the user on the device. The device is one having a limited data entry interface. Examples of the device include mobile phones, remotes for interactive televisions, and other limited data entry computing devices.

In another embodiment, a method for assigning a personal information number (PIN) to access digital services from a device is disclosed. The method includes establishing a PIN for the device from a website. The establishing includes, (i) receiving identification of a user from credential data including a user name and password; (ii) receiving selection of a unique identifier for a device to be associate with a fast login process to access digital services; (iii) receiving the PIN from the user to establish the fast login process on the device for accessing the digital services. The method also includes confirming the PIN on the device. The confirming includes, (i) from the device, receiving access request to the digital services; (ii) examining the unique identifier as received from the device as a result of receiving the access request for the digital services from the device; (iii) forwarding the user name of the user to the device; (iv) receiving entry of the PIN from the device; and (v) confirming that the PIN received from the device matches the PIN received from the user when establishing the fast login process. The device is one having a limited data entry interface. Examples of the device include mobile phones, remotes for interactive televisions, and other limited data entry computing devices.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings.

FIGS. 1A-1E illustrate user interfaces for enabling assignment of a PIN for fast login on particular devices, in accordance with one embodiment of the present invention.

FIGS. 2A-2D illustrate authentication process carried out on a device, to enable the PIN assigned for fast login, in accordance with one embodiment of the present invention.

FIGS. 3A-3H illustrate another example of a device, which may be provided with fast login access through a PIN assigned for that device, in accordance with one embodiment of the present invention.

FIG. 4 illustrates a flow chart diagram of the method operations that may be performed to establish and confirm a PIN for fast login on a particular device, in accordance with one embodiment of the present invention.

FIG. 5 illustrates a flow chart diagram of a more detailed description of a method for establish and confirm a PIN for fast login on a particular device, in accordance with one embodiment of the present invention.

### DETAILED DESCRIPTION

Broadly speaking, the embodiments of the present invention provide methods for assigning a fast login PIN to particular devices, so full credential information need not be entered on limited data entry interfaces to use particular digital services, but still enabling high security and authentication.

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention. Several exemplary embodiments of the invention will now be described in detail with reference to the accompanying drawings.

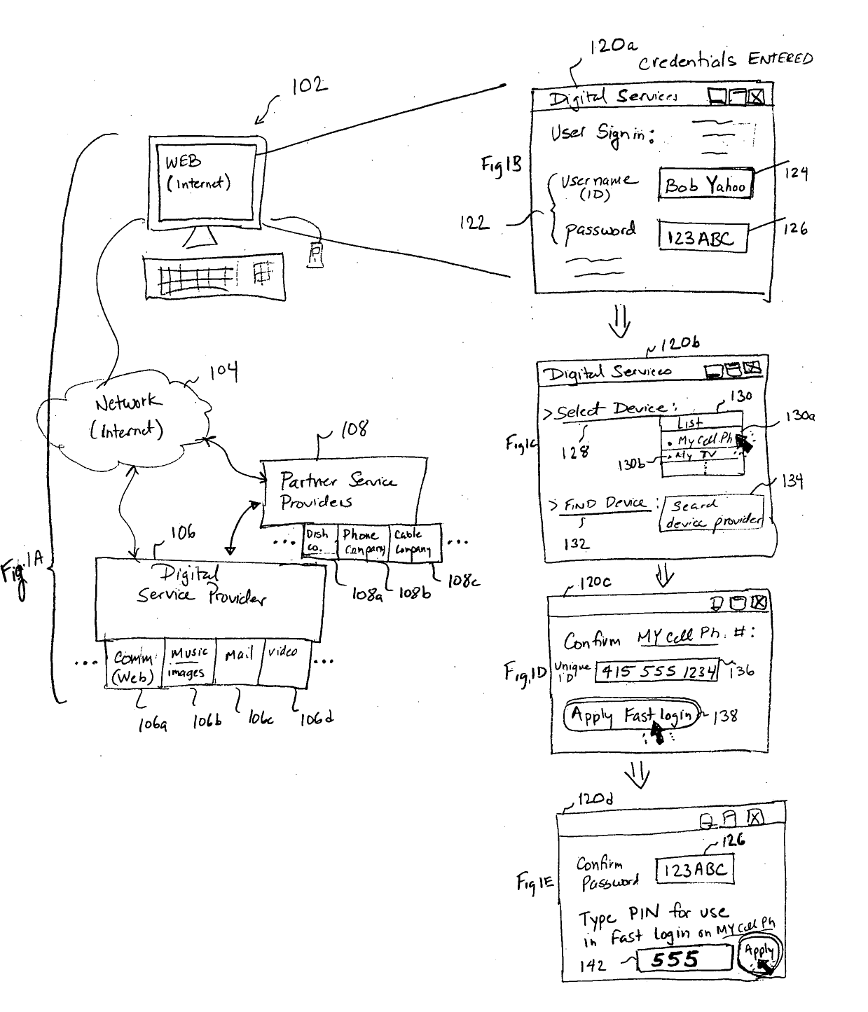

FIG. 1A illustrates a system for computing, connecting to networks, and interfacing with networked entities, service providers and service partners, in accordance with one embodiment of present invention. In FIG. 1A, the computing system 102 is shown having access to a network 104. The network 104 can either be a local network or a wide area network, such as the Internet. The Internet, as is well known, is defined by an ever growing number of entities, computing resources, storage, databases and networks that provide content, enable execution of data, access of data, and transfer of data. The type of data and functionality will depend on the particular needs of an infrastructure or individuals accessing the data. In one embodiment, the computing system 102 will allow a user to access the Internet (e.g., WEB), and visit websites that are hosted by particular service providers, partners, companies, or individuals. In the example provided, a user may access the Internet through a computing device 102 by way of network 104, and communicate with or access a digital service provider 106.

The digital service provider 106 may operate a website that provides a multitude of services in addition to providing access to websites, searches, and information. One example of a digital service provider may be an Internet company such as Yahoo, Inc., of Sunnyvale, Calif., which provides searching capabilities, services, and links to various information. The digital service provider 106 may therefore provide services related to communications 106a, music and/or images 106b, electronic mail services 106c, video data 106d, etc., among other services. In addition to providing a multitude of services and providing access to information, the digital service provider 106 may also be working with other partner service providers 108 to extend or augment service possibilities and offerings.

Other partner service providers 108 may be those service providers 108, and such service providers may have an emphasis or access to specialized types of media and services. In one embodiment, the partner service provider 108 may be a dish company 108a that provides digital video and/or data by way of satellite dish communications, or a phone company 108b that provides telephony and/or data. Another example of a partner service provider 108 may be a cable company 108c, which may provide analog and/or digital content, that is then shared or provided to users of the digital service provider 106.

In some examples, the digital service provider 106 may be able to provide its content on the native interfaces of the partner service provider's 108 system. In one example, a cable company 108c may be able to provide access to digital service provider 106 content, such as mail, communication, or web access. As can be understood, the multitude of services, digital content and providers are growing, and the variations of access to such services is also growing. In order to safeguard access to the various services to users that have paid or subscribed to the various services, the digital service providers and partner service providers limit access to users by assigning users credentials. As used herein, a credential is typically defined in terms of a user name and password, or combination thereof.

By providing a secure combination of input data that the user has to provide, the digital service providers are able to prevent unauthorized use of the various services. Additionally, the digital services that are being provided by the digital service providers 106 and partner service providers 108, for example, have been growing in terms of the type of devices that can access the various services. In recent years, portable devices such as mobile phones, PDAs, and other small computing devices have been provided with more access to digital services, and these digital services require that users authenticate themselves before accessing various digital service products.

As mentioned above, these digital services are being provided for mobile phones, and mobile phones are typically provided with less than a full qwerty keyboard. Without access to a full qwerty keyboard, users are left with having to access or input data for verifying credentials through a very limited data entry interface. A mobile phone, for example, includes all the basic numbers for dialing standard numbers, and in order to access other keys to enter letters or symbols, a user is required to tap on a particular number several times (and hit shift keys) until the desired digit, symbol or letter appears on the screen.

However, because users are required to enter more complicated credentials to avoid theft or unauthorized use of services, users are required to enter these complicated strings of letters and numbers and symbols through a very limited keyboard. Additionally, other non-standard computing devices are starting to provide access to digital services, such as video and television services. Many cable and digital video providers are enabling users, by way of a television screen, to surf the Internet, access mail, or perform other tasks that are typically performed using a computer. However, to access these digital services, users are required to authenticate themselves by entering their credentials into a screen on a television monitor.

Many times, users that are accessing digital services from an interactive television, are required to use a simple remote control to enter their credentials and other symbols and data to gain access to the digital services. As mentioned above, entering credential information on a screen will expose the credential information to those sitting in the same room or viewing the same television set. Also mentioned above, ways for masking the credential data are also provided, but masking credential data on a large screen introduces the difficulties of remembering which keystrokes had been previously entered, or the position of the cursor relative to the different locations on a screen. Furthermore, if the credential information is being entered on the screen when others are present, the keystrokes or key entry buttons being pushed on the remote control are easily identifiable by people in the vicinity, and will thus expose the credentials of the user.

Accordingly, one embodiment of the present invention provides a method and system for enabling users having limited data entry interfaces to use a fast login personal identification number (PIN) to access services from particular devices. As will be described below, the process includes first establishing a PIN to be used for a fast login through a web portal (e.g., a website of a service provider), and then followed by authentication from the device that is to be enabled with a PIN for fast login.

One embodiment of the present invention requires that a PIN be created for fast login for only one particular device. A user can therefore generate multiple fast login PINs for other devices, but each PIN will be assigned to a particular device. Once the PIN has been assigned to a particular device and authenticated on the device, a user can then manager whether to cancel, or update the PIN from a web portal by entering the user's complete credential information.

With this overview in mind, one method for establishing a PIN will now be described with reference to FIGS. 1B through 1E. It should be noted that the screen shots are provided to simply illustrate the functionality, and their actual presentation will vary, depending on layout arrangement and other factors. In FIG. 1B, a screen 120a is provided upon having a user access a particular website of a digital service provider. The digital service provider may provide various content and services, and will protect the services for particular registered users by requiring entry of credential data 122. If the user has already registered his or her credential data 122, the user is prompted to sign in to the digital service provider at screen 120a by entering their user name 124 and password 126.

As used herein, the user name can also be referred to as an ID or other identifier that the user would like to use in combination with a password. In some embodiments where the digital service provider 106 is Yahoo, Inc., of Sunnyvale, Calif., the user name is the Yahoo ID assigned to the user.

In FIG. 1C provides a screen 120b where the user is prompted to select a device 128 from a list 130, for which the user wishes to set parameters associated with the device. In this example, the user is provided with a list of devices that have been previously registered with the digital service provider 106. In this example, the user has registered My Cell Ph 130a. Also registered is My TV 130b. Other devices could also be included in the list 130, but for ease of understanding, the list only provides an example of a cell phone and a television. The user may also be provided with the option to find other devices 132 by performing a search for devices or providers 134. Because the user has selected My Cell Ph 130a, the process moves to FIG. 1D where as screen 120c asks the user to confirm the telephone number for My Cell Ph.

In this example, the telephone number is a Unique Identifier 136. The unique identifier 136 in this example, is telephone number 415 555 1234. If confirmation of the telephone number for My Cell Ph is correct, the user is allowed to apply for a fast login 138 option for this particular device. In FIG. 1E, the user is provided with screen 120d that will require the user to confirm its password 126. The password 126 is essentially the password component of the credential data 122 of FIG. 1B. If the password is confirmed, the user will be provided with an indicator that will request the user to type a PIN for use in fast login for the particular device My Cell Ph. As shown, the user will select a PIN of 555 at 142. Once the user has entered his or her PIN for use on this device, the user may apply the PIN to the device. At this point, the process of assigning or mapping a PIN to a particular device has been completed.

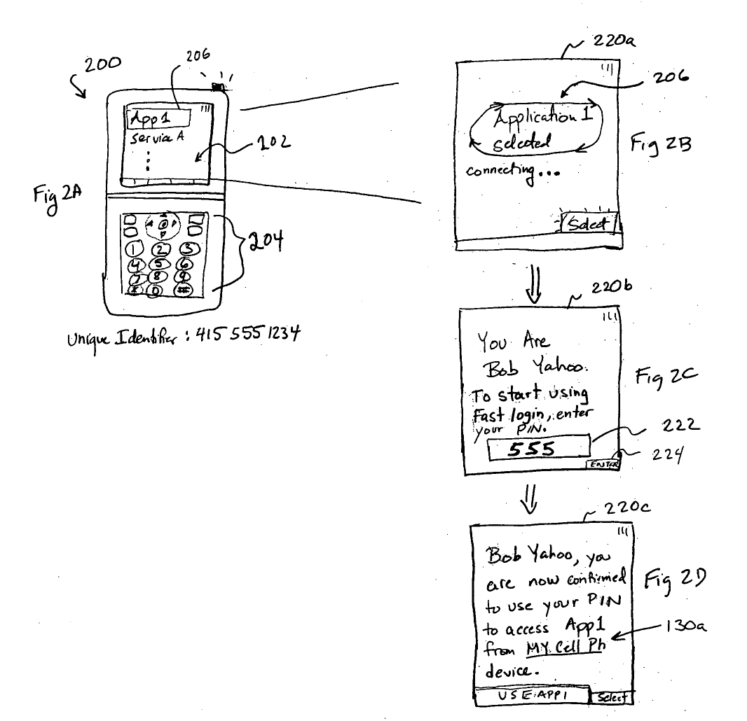

FIG. 2A illustrates a mobile phone 200 having a screen 202, a limited data entry interface 204, and applications on the screen 202, such as Application 1 (App 1) 206. A Unique Identifier is associated with the mobile phone 200. Each device will have its own Unique Identifier, and the Unique Identifier will vary depending on the type of device.

In the example of a mobile phone 200, the Unique Identifier may be its telephone number such as 415 555 1234. Other devices will have other types of Unique Identifiers, such as serial numbers, revision numbers, account numbers, combinations or other combinations of data. In the example of a set top box, a set top box may have its serial number, in the example of a television, the television may also have its serial number or identifier associate therewith. Accordingly, the Unique Identifier will vary depending on the device, but each device should have its own Unique Identifier of some type.

As defined in FIGS. 1B through 1E, a PIN was established for a particular device, and the particular device in this example, is mobile phone 200. In FIG. 2B, the screen of the mobile phone is shown where the user has selected Application 1, which connects to particular services. As noted above, the services may vary depending on the provider, and examples of the services may be web access, mail access, communication access, game and application access, instant messaging access, music download access, and without limitation, other digital services. In this example, the user has selected Application 1 206.

The process then moves to FIG. 2C where the screen 220b will change to a notification to the user who, in this example, is Bob Yahoo. If the mobile phone 200 was previously assigned a PIN, as was the case in the method operations of FIGS. 1B through 1E, the mobile phone 200 will be identified by a server of the service provider upon access of the Application 1, in FIG. 2B. Thus, FIG. 2C in screen 220b will identify the user of this mobile phone 200 as “Bob Yahoo.” Bob Yahoo will then be requested to enter the PIN for fast login in screen 220b. Assuming that the owner of mobile phone 200 is the same authorized user with the credentials 122 of FIG. 1B, the user of the mobile phone 200 will understand and know what PIN to enter in PIN entry box 222. Also assuming that the authorized user is handling mobile phone 200, the user will enter 555 as the PIN and then select enter 224.

The PIN will then be transferred back to the server of the service provider for verification that the PIN 555 matches the PIN that was established for this device by the user in FIG. 1E. If the PIN matches, the process moves to FIG. 2D where, on screen 220c, where Bob Yahoo is informed that his PIN has been confirmed to access Application 1 from this mobile phone 200. Mobile phone 200 was previously named My Cell Ph 130a by the user.

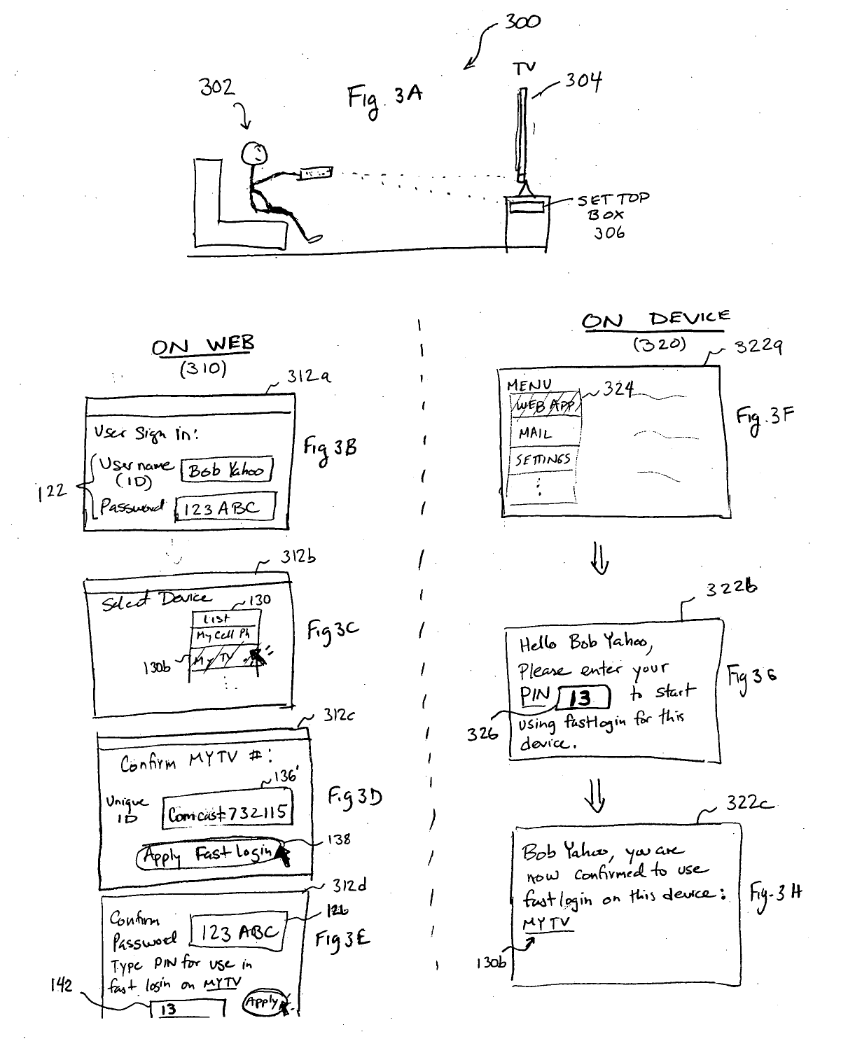

FIG. 3A illustrates an environment 300 where a user 302 may be attempting to access digital services from a television 304 or a set top box 306. As mentioned above, use of a remote control to access a television 304 or set top box 306 may be cumbersome when the user 302 is requested to enter full credentials to access particular digital services. Due to the limited data entry interface of the remote control, one embodiment of the present invention will enable a user to assign a PIN for fast log-on to the services provided by the television 304, the set top box 306, or a combination of the two. In order to assign a PIN for fast log-on in environment 300, the user will first be required to perform operations on the web 310 and then operations on the device 302.

In FIG. 3B, the user is provided with a screen 312a where the user is requested to enter credential information 122. The user has entered his credential information 122 by entering his user name and password. In this example, the user name may also be referred to as a user ID. Once the user has entered his credentials 122 appropriately in FIG. 3B, the method process moves to FIG. 3C, where on screen 312b, the user is required to select a device. In this example, the user selected My TV 130b. In FIG. 3D, screen 312c is provided that requests that the user confirm a Unique Identifier of My TV 130b. The user then enters a Unique ID set top box 306, which may include Unique ID “comcast732115,” entered in box 136′.

As mentioned above, the format and content of the Unique ID varies depending on the device, and the Unique ID may be obtained from the device manufacturer, supporter, or provider. In some circumstances, the Unique ID is assigned an account number, and the account number can be used for the confirmation in FIG. 3D. Once the appropriate Unique ID has been entered, the user may apply for a fast login by selecting button 138. In FIG. 3E, the user may be requested to confirm the password of the user which was entered in FIG. 3B. If the password is correct, the user may be requested to enter a PIN for use in fast login on My TV in box 142. In this example, the user selected the number 13 to enter as the PIN in box 142, and then the user may select apply.

At this point, the server (or servers) of the digital service provider will hold information that the user desires to register a particular device, e.g., My TV, as a device that can access digital services by use of a PIN for fast login. Activation of the PIN will then require the user to attempt access from the device and then enter the PIN. FIGS. 3F through 3H illustrate the confirmation of the PIN on the device 320. As shown in FIG. 3F, the user may surf through different menus using the remote control, and then may attempt to access a web application 324. When the user attempted to use the web application (Web App) 324 on the device, the request to use the Web App 324 would communicated back to the server or servers of the service provider, where confirmation of the device's Unique ID is communicated back to the server.

At this point, the server will determine that the device requesting access to the web application 324 is one that has been previously targeted for fast login. A screen 322b will then be provided in FIG. 3G that will communicate to Bob Yahoo to enter his PIN to start using fast login for this device. The user will then enter the number 13 in box 326 on the screen 322b. If the number 13 is the same PIN that was entered on the web 310 when establishing the PIN for fast login, the process will confirm that a match exits and then in FIG. 3H, a screen 322c will be provided to Bob Yahoo. The user will then be informed that he is now confirmed to use fast login on this device, the device being My TV 130b.

Thereafter, when the user attempts to use Web App 324, the user simply needs to input PIN 13 to access the Web App. As noted above, entering PIN 13 into the remote control is much easier than entering the complete credential data onto the screen where others may view the data, and entering the PIN 13 can be used without exposing the user's credentials which may then be inappropriately used on the web by others. If the PIN 13 or any other PIN assigned to a device needs to be changed for security purposes or the user no longer owns a particular device, the user can simply log onto the web, enter the full credential information, and then manage the fast login PINs for each of the devices that were assigned a fast login PIN.

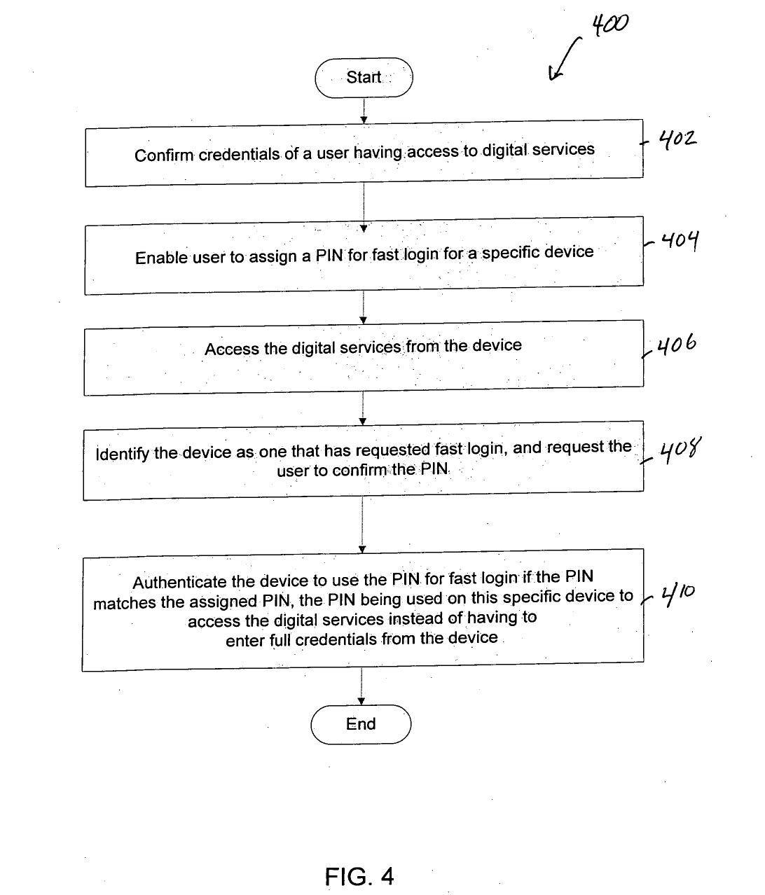

FIG. 4 illustrates a flow chart of the process operation performed in order to assign and use a PIN for fast login on a particular device. The method begins at operation 402 where credentials of the user having access to digital services are confirmed. As noted above, the user, when accessing a website of a service provider may be requested to enter his or her credentials. In operation 404, the user is allowed to assign a PIN for fast login for a specific device. Examples of assigning a PIN to different devices is provided with reference to FIGS. 1A through 3H. In operation 406, the digital services may be accessed from the device. When the digital services are accessed from the device, and the device has previously been assigned a PIN, the method will move to operation 408 where the device is identified as one that has been requested for fast login. Because it has been identified as one that has requested fast login, the user is then requested to confirm the PIN that was assigned by the user previously.

In operation 410, the device is authenticated to use the PIN for fast login if the PIN matches the assigned PIN. The PIN can then be used on this specific device to access the digital services instead of having to enter full credentials from the device. As noted, entering full credentials from a device with limited data entry interfaces is difficult, and a PIN can replace the need to enter full credential information, but yet ensure that the appropriate user has access to the device and can manage the fast login PIN in case of a breach.

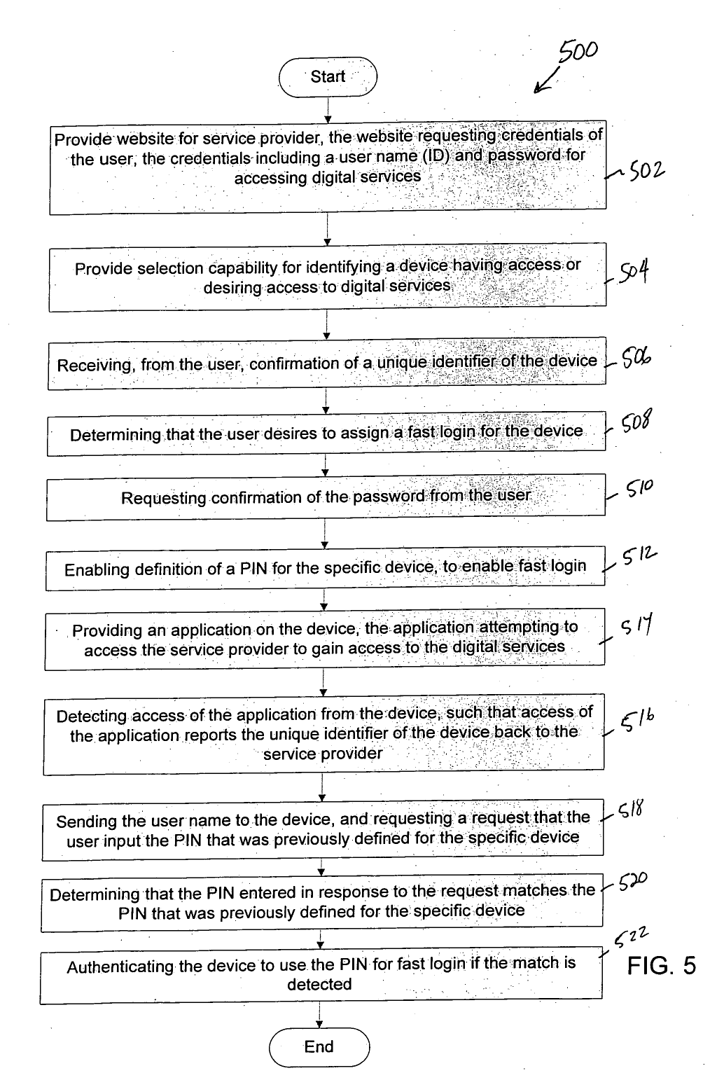

FIG. 5 illustrates a more detailed flow chart diagram 500 illustrating process operations performed in order to assign and use a PIN for fast login on a particular device. The method begins at operation 502 where a website is provided for a service provider, and the website will request credentials of the user.

The credentials may include a user name (e.g., ID), and a password for accessing the digital services provided by the digital service provider. In one embodiment, the website may be the website provided by Yahoo, of Sunnyvale, Calif. The digital services may be web access, mail access, communication access, mobile communication services, video and picture data services, and the like without limitation to other data. The method then moves to operation 504, where selection capability is provided by the website to identify a device having access or desiring access to digital services. For example, if a mobile phone has been previously registered with the service provider, the user may simply select the mobile phone. If the mobile phone has not been previously registered with the service provider, the service provider can then register the mobile phone and then select a mobile phone. Similar processes can occur or be processed for other types of devices.

The method then moves to operation 506 where a confirmation of a Unique Identifier of the device is received from the user. The Unique Identifier is the identifier that defines the particular device. As mentioned above, the Unique Identifier can take on any number of forms so long as it is able to identify the device or user associated with that device. In operation 508, it is determined that the user may desire to assign fast login for a particular device. At this point, in operation 510, the user is requested to confirm the password of the user so that only authorized users can assign a fast login to a particular device. This operation is useful when a user may be logged on to services automatically, such that the credentials identify the user as being a particular user.

However, in order to ensure that other people that may access the same computer or computing device at a later time when the credential information has already been confirmed, does not attempt to assign a fast login to a device without authorization. For this reason, it is desired to optionally have the user reconfirm the password in operation 510. In operation 512, the user is allowed to define a PIN for the specific device to enable fast login. An application is provided on the device, and the application may attempt to access the service provider to gain access into digital services. At the server of the digital service provider, it is detected that access of the application from the device is attempted. The access will report the Unique Identifier device back to the service provider. The service provider in operation 518 will then send the user name to the device, as the device has been identified by the service provider.

The server will also request that the user input the PIN that was previously defined for the specific device. This confirmation of the PIN is then reviewed in operation 520 to see if the PIN matches the PIN that was previously defined by the user. If a match is confirmed, in operation 522, the device is authenticated to use the PIN for fast login.

It will be obvious, however, to one skilled in the art, that the present invention may be practiced without some or all of these specific details. In other instances, well known process operations have not been described in detail in order not to unnecessarily obscure the present invention.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for assigning a personal information number (PIN) to a device for accessing digital services from the device, comprising:
(a) defining a PIN for the device from a website upon confirming credentials of a user;
(b) mapping the PIN to the device at the website;
(c) receiving an access request from the device for digital services; and
(d) forwarding the device a request to enter the PIN on the device;
wherein if the PIN entered on the device matches the PIN mapped at the website, the PIN is activated to enable accessing the digital services from the device using the PIN without having to enter credentials of the user on the device.

2. A method for assigning a personal information number (PIN) to a device for accessing digital services from the device as recited in claim 1, wherein the credentials include a user name and password of the user.

3. A method for assigning a personal information number (PIN) to a device for accessing digital services from the device as recited in claim 1, wherein mapping the PIN to the device includes identification of a unique identifier for the device and associating the PIN with the device having the unique identifier, the device having the unique identifier having access to the digital services.

4. A method for assigning a personal information number (PIN) to a device for accessing digital services from the device as recited in claim 1, wherein the digital services are identified as one or more of applications, Internet access, Internet services, interactive content, or communication services.

5. A method for assigning a personal information number (PIN) to a device for accessing digital services from the device as recited in claim 1, wherein receiving the access request from the device for digital services of operation (c) includes,
(i) connecting from the device to a server associated with the website, the connecting is configured to transmit the unique identifier of the device to the server so that the server can determine if the device having the unique identifier has been mapped to the PIN;
(ii) if the device has been mapped to the PIN, the method proceeds to operation (d).

5. A method for assigning a personal information number (PIN) to a device for accessing digital services from the device as recited in claim 5, wherein the forwarding the device the request to enter the PIN on the device of operation (d) includes communicating the user name to the device for display on a screen of the device, and then requesting the entry of the PIN on the device.

6. A method for assigning a personal information number (PIN) to a device for accessing digital services from the device as recited in claim 5, wherein the entered PIN on the device is communicated to the server, the server determines if the PIN entered on the device matches the PIN mapped at the website of the server.

7. A method for assigning a personal information number (PIN) to a device for accessing digital services from the device as recited in claim 1, wherein the PIN, once activated, serves to allow access of the digital services from the device, such that PIN remains valid until a change is made by the user of the PIN at the website, but such change is only allowed upon confirming the credentials of the user.

8. A method for assigning a personal information number (PIN) to a device for accessing digital services from the device as recited in claim 1, wherein the device is one having access to a network.

9. A method for assigning a personal information number (PIN) to a device for accessing digital services from the device as recited in claim 8, wherein the device is a mobile phone, a portable computing device, a set top box, a television system, or a computing device.

10. A method for assigning a personal information number (PIN) to a device for accessing digital services from the device as recited in claim 1, wherein the device has a limited data entry interface.

11. A method for assigning a personal information number (PIN) to access digital services from a device, comprising:
(a) establishing a PIN for the device from a website, the establishing including,
(i) receiving identification of a user from credential data including a user name and password;
(ii) receiving selection of a unique identifier for a device to be associate with a fast login process to access digital services;
(iii) receiving the PIN from the user to establish the fast login process on the device for accessing the digital services;
(b) confirming the PIN on the device, the confirming including,
(i) from the device, receiving access request to the digital services;
(ii) examining the unique identifier as received from the device as a result of receiving the access request for the digital services from the device;
(iii) forwarding the user name of the user to the device;
(iv) receiving entry of the PIN from the device; and
(v) confirming that the PIN received from the device matches the PIN received from the user when establishing the fast login process.

12. A method for assigning a personal information number (PIN) to access digital services from a device as recited in claim 11, wherein,
if a match is confirmed, the user is able to access the digital services from the device using the PIN without having to enter the user name and password of the user's credentials.

13. A method for assigning a personal information number (PIN) to access digital services from a device as recited in claim 11, wherein receiving the selection of a unique identifier for a device to be associate with a fast login process to access digital services includes determining a type of the device, the type of the device includes one of a mobile phone, a portable computing device, a set top box, a television system, or a computing device.

14. A method for assigning a personal information number (PIN) to access digital services from a device as recited in claim 11, wherein the device has a limited data entry interface.

15. A method for assigning a personal information number (PIN) to access digital services from a device as recited in claim 14, wherein the limited data entry interface is not a qwerty keyboard, but can include a phone key pad, a remote control for a set top box or a television.

16. A method for assigning a personal information number (PIN) to access digital services from a device as recited in claim 11, wherein the PIN, once activated, serves to allow access of the digital services from the device, such that PIN remains valid until a change is made by the user of the PIN at the website, but such change is only allowed upon confirming the credentials of the user.

17. Computer readable media including program instructions for assigning a personal information number (PIN) to a device for accessing digital services from the device, the computer readable media comprising:
(a) program instructions for defining a PIN for the device from a website upon confirming credentials of a user;
(b) program instructions for mapping the PIN to the device at the website;
(c) program instructions for receiving an access request from the device for digital services; and
(d) program instructions for forwarding the device a request to enter the PIN on the device;
wherein if the PIN entered on the device matches the PIN mapped at the website, the PIN is activated to enable accessing the digital services from the device using the PIN without having to enter credentials of the user on the device.

18. The computer readable media as recited in claim 17, wherein the credentials include a user name and password of the user.

19. The computer readable media as recited in claim 17, wherein mapping the PIN to the device includes identification of a unique identifier for the device and associating the PIN with the device having the unique identifier, the device having the unique identifier having access to the digital services.

20. The computer readable media as recited in claim 17, wherein receiving the access request from the device for digital services of operation (c) includes,
(i) program instructions for connecting from the device to a server associated with the website, the connecting is configured to transmit the unique identifier of the device to the server so that the server can determine if the device having the unique identifier has been mapped to the PIN;
(ii) program instructions for determining if the device has been mapped to the PIN, and if mapped, the method proceeds to operation (d).
